(19) United States
(12) Patent Application Publication
(10) Pub. No.: US 2008/0004744 A1
(43) Pub. Date: Jan. 3, 2008

(54) Method for Adapting Parameters of a Control or Regulating Device

(75) Inventors: Gerhard Heinemann, Erlangen (DE); Eckart Krebber, Erlangen (DE); Alexander Wagenpfeil, Rottenbach (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 11/575,445

(22) PCT Filed: Sep. 9, 2005
(86) PCT No.: PCT/EP05/54509

§ 371 Date: Mar. 16, 2007

(30) Foreign Application Priority Data
Sep. 17, 2004 (DE) 10 2004 045 196.6

(51) Int. Cl. G05B 19/04

(52) U.S. Cl. 700/173

(57) ABSTRACT

The invention relates to a method for adapting the parameters (32) of a control and/or regulating device (1,4). The control and/or regulating device (1,4) is provided in particular for a machine tool or production machine. A parameter (32) has one or several attributes (34), wherein the attributes (18,34) of several parameters (32) are determined by means of at least one set of data (14,16,17) for attribute description. The invention also relates to a control and/or regulating device for carrying out said method.

The invention relates to a method for adapting parameters of a control and/or regulating device, the control and/or regulating device being provided, in particular, for a machine tool or a production machine. The invention also relates to a corresponding control and/or regulating device and to a device for carrying out the method, respectively.

In many cases, control and/or regulating devices are no longer fabricated especially for particular applications, but control or regulating devices are developed by means of which the most varied applications can be solved. Thus, control or regulating devices form a type of platform which can be used for various applications. For example, various machines for various markets or branches, e.g. machine tools, production machines, packaging machines or the like, can be controlled and/or regulated by means of a control and/or regulating device. Due to the great variability of the control and/or regulating device, various device forms are also possible, for example. For example, the various forms relate to different hardware forms, different options with respect to the software and/or also different hardware topologies. Control and/or regulating devices can also be classified with respect to the users intended for operating them. Users can be, for example, specialists such as engineers, or also electricians or assistants. Within a branch or market, too, control and/or regulating devices can also exhibit differences with respect to different applications. Machine tools can have, for example, three, four or five axes. Control and/or regulating devices can also be used for implementing standard applications such as, for example, winders, flying shears or a lifting function for hoists.

The applications described above can exhibit a special feature so that this requires a special function and/or an associated setting. These problems can be additionally made more difficult, for example, in that the drive application implemented in each case by a customer is not yet known at the development time or at the engineering time of the control or regulating device. Furthermore, the amount of possible different drive applications for a control and/or regulating unit is so large, for example, that it is not possible to permanently integrate a special type of operation into the control and/or regulating device for each application. An example of a control and/or regulating device is a drive device which is used for driving an electrical machine. The drive unit has, in particular, a regulating part, wherein the regulating part can also be used for control tasks and, furthermore, the drive unit has a power section which has a converter circuit.

A further problem is presented by modular machine concepts in which the functionality can be varied by upgradable options. In such machines, particularly machine tools, the topological extension, for example with respect to the number of drive axes or the number of sensors or the like of a drive system, is not known in advance. In such systems, the number of parameters for these optional components must be adapted to the degree of extension of the machine. In this context, particular arrangements for a varying addressing of the components and their parameters due to different network topologies, via which these components can be linked to the drive system, must be taken into consideration. The requirements with respect to high modularity and applicability lead to a drive device which can be used in many ways or, respectively, a control and/or regulating device which can be used in many ways, having a multiplicity of adjustment parameters. The number can possibly be more than 1000. A commissioning person must then adapt such a large number of parameters to the respective application. An application is, for example, an application as flying shears, as control or regulation for a plastic injection molding machine or the like.

Although many parameters are available for the parameterization, it is also possible that only a few parameters need to be changed for an application. However, a user of the control or regulating device is confronted with the totality of parameters which requires a wide range of knowledge of the user. High complexity of the control and/or regulating device with simultaneous confusion of parameters to be adapted, particularly setup parameters, is an error source and, for example, leads to long commissioning times.

To provide simplified commissioning for particular standard applications, various sets of preset values, so-called default values, can currently be selected for the parameterization via a setup parameter. However, this selection is limited to a small number of predefined simple applications for reasons of expenditure. In addition, these selectable default settings are permanent and cannot be variably adapted to the different configuration level of modular machines. The application which can be selected in the control or regulating device can also be advantageously provided at the same time in the same form on external tools such as, e.g., on a commissioning program on a PC which leads to extensive boundary conditions with respect to the compatibility between the software version of the control or regulating device and, e.g., a commissioning program running on an external tool.

It is the object of the present invention, therefore, to provide for simple parameterization of a control or regulating device of a machine tool or production machine.

The object is successfully achieved by means of a method for adapting parameters to a control and/or regulating device having the features as claimed in claim 1 and, respectively, the object is also successfully achieved by means of a control and/or regulating device having the features as claimed in claim 8. Dependent claims 2 to 7 and 9 to 12 represent inventive developments of the invention.

In a method for adapting parameters of a control and/or regulating device, the control and/or regulating device being provided, in particular, for a machine tool or production machine, a parameter has one or more attributes, wherein the attributes of a number of parameters are defined and/or changed by means of at least one set of data for the attribute description. In this arrangement, an attribute is newly defined even in the case of a change. The set of data represents description data for parameters and for attributes of the parameters, respectively.

The attributes are used for describing the parameter. In this context, a parameter can be described, for example, by one or by a number of attributes. The number of attributes which a parameter has depends on the parameter. Attributes of a parameter are, for example:
a default value of a parameter, that is to say a value which is stored as parameter value after resetting the system, e.g. a number 1.5 for a gain factor,
a minimum and/or maximum set up limit for a value of a parameter,
an information item on whether a parameter is visible in a display on a screen of an operating device or whether this parameter is invisible, which can be made dependent, e.g., on the type of display,
an information item on whether a parameter can be written, read or stored,
an information item on the accessibility of a parameter, i.e. an information item on the unrestricted or restricted accessibility of a parameter such as, e.g., for an access for all users of the control or regulating device or only for a machine manufacturer, for experts, for operating personnel or trained personnel, etc.

These are different types of attributes.

In an embodiment of the method, parameters of the control and/or regulating device are adapted to an application by means of the set of data for attribute description, wherein the adaptation, in particular, relates to an adaptation of the attributes of the parameters and attributes are changed and/or defined by the adaptation.

The set of data is generated, for example, by a machine manufacturer as OEM. In particular, it is advantageous if a set of data can be modified. Modification is carried out, for example, by means of an editor.

In a further embodiment of the method, a number of parameters are changed in at least one of the following points by means of the adaptation, a point relating to at least one attribute of a parameter:
Adaptation of a presetting value (a parameter thus has a preset value, this value representing an attribute, the value being reset with the aid of the set of data. The presetting is, for example, a manufacturer's setting of the control and/or regulating device.),
adaptation of a permissible range of values,
adaptation of a visibility of a parameter on a display (the display occurs, for example, on a screen.),
adaptation of an access right (for example, a value of a parameter can only be changed with particular access rights. These access rights represent attributes. The access rights relate, for example, to programs, macros or also different operating personnel of the control and/or regulating device),
adaptation of a legibility setting
adaptation of a writeability setting
adaptation of a storage authorization of the parameter (32).

A set of data for attribute description can also be formed, for example, in such a manner that this set of data has a complete description of all parameters or also only a delta description, that is to say a difference description with respect to a basic parameter description already existing. This delta description reduces the volume of data with respect to a set of data which has data for describing all attributes of parameters of a control and/or regulating device. The basic parameter description is thus a description of the attributes of one or more parameters which represents a basic setting.

In a method for adapting setup capabilities of a control and/or regulating device to a particular application or a group of applications, the adaptations are available by means of descriptions in a set of data. The set of data can have, for example, one or more files. However, a set of data can also be arranged in such a manner that it has a different data format than that which is provided for a file.

The method according to the invention can also be designed in such a manner that the adaptations can relate to individual function objects or software modules of a control and/or regulating device or also to the complete control and/or regulating device.

In the method described, it is advantageous if the descriptions for the adaptation, that is to say, in particular, the sets of data for the attribute description, can be reloaded by any persons at any time into the control and/or regulating device or into a memory used by it. The set of data for the attribute description can thus be stored, for example, on the control or regulating device or also on a storage medium such as, e.g., a memory card or a hard disk. The set of data for the attribute description can also be conveyed, e.g., to a control or regulating device by means of a data communication device such as, e.g., a radio link or a bus link. The set of data is deposited, for example, in a file or in a number of files. The set of data can be reloaded, for example, at any time by any person (user). The set of data for the attribute description, briefly called set of data, can be advantageously interpreted on a drive device and/or a control and/or regulating device itself. The set of data can also be used for an external device, e.g. for commissioning or for engineering. The tool used for the engineering of an application is, for example, a PC (personal computer).

In a further advantageous embodiment of the invention, a set of data can be applied several times in succession to a control and/or regulating device. The set of data can be present in various embodiments, for example as readable (ASCII) text or as binary file.

In an advantageous embodiment, an attribute of a parameter can be activated by selecting a parameter or by selecting a machine data item or service. Attributes of parameters can be preset either directly on the control and/or regulating device, e.g. of a drive, or by means of an external device, that is to say off-line or, for example, also in the plant.

In an advantageous embodiment of the method, in which an adaptation of parameters of the control and/or regulating device is possible by means of the set of data for the attribute description, an adaptation to an application is carried out by means of the set of data. The control and/or regulating device can thus be reorganized in a simple manner in such a way that various applications can be carried out with the control and/or regulating device merely by adapting parameters. In this context, such applications do not need to be predefined during the production of the control and/or regulating device but can be transferred subsequently to the control and/or regulating device.

In a further advantageous embodiment of the method, values of parameters are defined by means of the set of data for the attribute description. For example, this relates to values with respect to gains in a control loop or a timing element in an integration. Defined values of parameters can also be defined in such a manner that they are set and locked against overwriting.

In a further advantageous embodiment, the control and/or regulating device has a reset parameterization, the reset parameterization being defined or definable by means of the set of data for the attribute description. When a reset is carried out, parameter values have previously been reset within a control and/or regulating device, particularly in a drive controller or drive regulator, to values which are predetermined by the manufacturer of the control and/or regulating device. Attributes and a set of data for the attribute description now make it possible, in particular, to define reset values application-specifically.

In a further embodiment of the method, a number of descriptions, that is to say sets of data for the attribute description, are present in the control and/or regulating device or a memory used by it, wherein a description can be selected among them and can be activated. The selecting and the activating can be advantageously done by means of a parameter, the latter being set, for example, by a user or in the plant.

At least some attributions of the control and/or regulating device are advantageously defined in such a manner that they are present again and become active even after resetting.

It is also advantageous if the description data (the set of data) can be evaluated by the control and/or regulating device without external aids. It is thus also of advantage if the description data can be loaded and interpreted on/by external tools.

In a further embodiment, it is possible that description data can be selected several times in succession and also with respect to different contents.

The method for adapting attributes is arranged, for example, in such a manner that the description of the attributes, that is to say the set of data, can be present in a different syntax. A number of sets of data can also have a different syntax.

In a further embodiment, a set of data has at least two mutually different description data of attributes of the parameters of a control and/or regulating device.

Apart from a method, the invention also relates to a control and/or regulating device, the control and/or regulating device being provided, in particular, for a machine tool and/or a production machine. The control and/or regulating device is, for example, a drive device or also a numeric controller. The control and/or regulating device is provided for carrying out a method described above.

In a control and/or regulating device according to the invention, parameters have attributes, wherein the attributes of a number of parameters can be defined by means of at least one set of data for the attribute description. Attributes are, for example, descriptions of parameters which reproduce the type of a value of a parameter, such as, e.g., integers. The control and/or regulating device can be used, in particular, for carrying out a method described above. In this context, the control and/or regulating device can be advantageously used, in particular, if the set of data for the attribute description has application-specific data.

The invention also relates to an engineering device by means of which a control and/or regulating device of the type described can be parameterized.

The set of data for the attribute description which has, for example, a file or a number of files, can be advantageously integrated into the control and/or regulating device by means of a macro, or also conversely. For example, a set of data can automatically execute a macro on start-up.

A control and/or regulating device has, for example, a computer system, an interpreter being a component of a non-real-time software of the computer system, wherein an executable macro can be loaded from a storage medium into the interpreter and can be executed by the interpreter and parameters can thus be determined by the interpreter for the parameterization of the control or regulating device and can be stored in a memory area.

The executable macro is loaded, e.g., from a storage medium into an interpreter implemented within a non-real-time software of a computer system and executed by the interpreter, wherein parameters are determined by the interpreter for the parameterization of the control or regulating device and are stored in a memory area.

In an advantageous embodiment of the method, the macro is executed during a start-up and/or during a reset of the control and/or regulating device. The executing is advantageously done automatically. The control and/or regulating device can thus be arranged in such a manner that its start-up and/or its resetting can be changed by means of a macro. The macro is called up during the start-up or during the reset. If there are a number of macros, a macro to be executed can be defined. It is also possible to use a macro, e.g., to run any parameterization sequences in an automated manner. For example, the macro can also be parameterized and/or reloaded into a control and/or regulating device.

The sequences in a first start-up or after a reset (bootstrap deletion) of the control and/or regulating device can be defined, for example, by a user without a special development environment of the engineering system. In this way, it is possible to initiate an automatic start-up of the control and/or regulating device. The control and/or regulating device automatically detects connected components such as, e.g., transducers, temperature sensors, shafts, etc. and starts itself up. For example, the wiring of a switchboard is produced automatically in accordance with a macro. During this process, e.g., signal interconnections can also be made which are protected against alteration.

In an advantageous embodiment, the control and/or regulating device detects an application and loads an application-specific set of data for the application description via a macro.

It is advantageous if the macro can be reloaded and/or executed at any time since the parameterization can then be changed by the user at any time.

It is also found to be advantageous if a user can be requested via the macro to input data. This provides for active communication with a user. Thus, e.g., the macros can produce text on a screen which requests the user for inputs. It is thus possible for the macro to determine the current machine configuration, e.g. with the aid of suitable questions which are set for the user by the macro.

It is also found to be advantageous if an embedded computer system is provided for the control and/or regulating device. Embedded computer systems are frequently used for controlling or regulating machine tools or production machines. Production machines are also understood to be automatic manipulating machines such as e.g. robots. In a further advantageous embodiment of the control and/or regulating device, the control and regulating device forms a uniform control and regulating system. Such a system can be used, e.g., for solving both control and regulating tasks. For this purpose, a uniform model of progress levels can also be formed in such a manner that it has a number of progress levels of different type with different priority, wherein different user and system levels are provided from the highest to the lowest priority and that in each case technology packets can be loaded into the engineering and/or run-time system by the user, that a data source for description information for system variables and possibly alarms and/or voice commands provides voice commands and/or system variables to the engineering system via a converter, that the system variables can be supplied with current data of the technical process from the run-time system and that further inputs can be made by the user via an operating interface of the engineering system.

At least one macro can be advantageously assigned to one progress level. The macro thus runs at the assigned progress level. If the macro has different instructions, each instruction can be allocated, for example, to a particular progress level. This has the advantage that a macro can be programmed optimized in time.

In a further embodiment, the macro can be executed during a start-up or and/or during a resetting of the control and/or regulating device. The execution is, for example, automatic. Especially during start-up or during the resetting, it is advantageous to allocate instructions of the macro to a progress level so that the resetting or the start-up can be concluded more rapidly.

If a number of macros are already programmed, a user can select and/or activate the macro which is of advantage to him. A macro can also be used in an engineering system. The engineering system is used, for example, for programming a user software. The utilization of the macro in an engineering system is analogous to the utilization in the control and regulating device.

In an engineering system for programming software which can be run on a control and/or regulating device, application-specific macros can be generated and/or executed.

Exemplary embodiments of the invention are shown in the drawing and will be explained in greater detail in the text which follows. In the drawing:

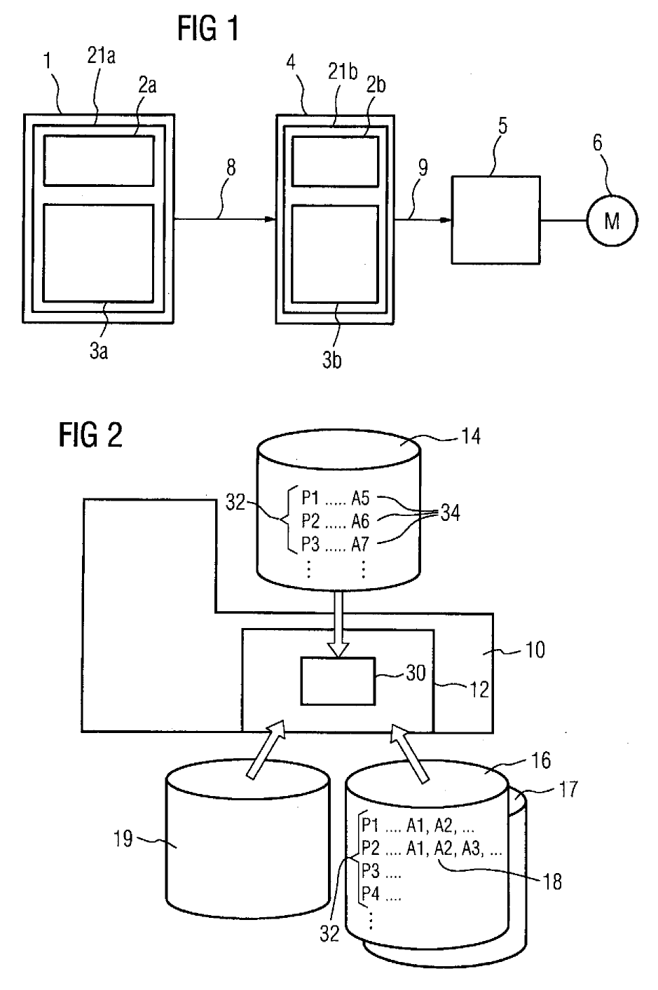

FIG. 1 shows the drive concept of a machine tool or production machine, and

FIG. 2 shows sets of data for attribute descriptions.

FIG. 1 diagrammatically shows the drive concept of a commercially available machine tool or production machine in the form of a block diagram. A controller 1 calculates nominal quantities for a regulator 4 and supplies these to the regulator 4 via a data link 8. The regulator 4, which is a regulating device, regulates, e.g., the motor speed of a motor 6 in accordance with the nominal quantities predetermined by the controller 1. Controlled output quantities are supplied by the regulator 4 via a connection 9 as input quantities to a converter 5 which feeds the motor 6. The necessary feedback of actual regulator quantities is not shown in FIG. 1 for the sake of clarity.

Due, for example, to high real-time requirements, the regulating device 4 is commercially implemented on the platform of a special embedded computer system 21b. The control device 1 is also implemented, e.g., in the form of an embedded computer system 21a. Embedded computer systems are frequently used in drive and automation technology. They are distinguished by the fact that they are integrated into the device to be automated and can also be operated independently, i.e. without the peripheral components such as, e.g., keyboard, mouse or screen, which are normally necessary for personal computers. In contrast to personal computers, the software of an embedded computer system is not started by the user but is permanently installed in the device in the form of so-called firmware and is automatically started when the device is switched on.

The embedded computer system 21a of the controller 1 has real-time software 3a which runs on a real-time operating system. Within the real-time software 3a, the essential control functionalities of the control device 1 are implemented. In addition, the controller 1 has non-real-time software 2a, particularly in the case of more complex machines. The non-real-time software 2a is essentially used for implementing operating and display functions of the machine. Accordingly, the regulating device 4 has an embedded computer system 21b with real-time software 3b for implementing the regulating functionality which runs on a real-time operating system and a non-real-time-capable software 2b which runs on a non-real-time operating system and is essentially used for implementing operating functionalities and display functionalities of the regulator 4.

Since it is intended to use the control device 1 or the regulating device 4 as in each case uniform hardware platform for the most varied machine types and applications, the parameterization of such a control or regulating device is elaborate and complex in machines currently used. Thus, e.g., a number of converters with a motor associated in each case can also be connected to the regulating device 4. Furthermore, various motor types can be used, e.g., or the controller 1 can also be connected to not only one regulator 4 but a number of regulators. In addition, e.g., the number of transducers for determining the actual quantities can be different for each machine. Since each type of machine and each machine configuration has its own individual parameterization and the number of parameters and the type of parameters can fluctuate depending on configuration, the parameterization of such a machine has previously been very complex.

The representation according to FIG. 2 shows a machine 10 which has a regulating device 12. The regulating device 12 has a code (programming) 30. Furthermore, the representation shows a set of data 14 which is a file with stored parameter values. The set of data 14 has parameters P1, P2 and P3 32, a parameter value A5, A6 and A7 34 being allocated to each parameter. The parameter values 34 are attributes of the parameters 32. The file 14, which represents the description data for the attribute description, can be supplied to the regulating device 12 (e.g. by means of a memory card). The representation according to FIG. 2 also shows an application-specific set of data 16 and 17. The application-specific set of data 16 also has attributes A1, A2, A3, A4, . . . 18 for the parameters 32. The application-specific parameter descriptions can be activated or deactivated, for example, by means of manufacturer's adjustment or e.g. by means of a parameter value. The sets of data 14, 16 and 17 can be supplied to the regulating device 12. A basic parameter description 19 can also be supplied. In the code 30, only basic properties are defined with respect to the parameters. Basic properties are, for example, the number of parameters and the associated attributes and their attribute type. Since the application-specific views can be defined in loadable files 16, 17, new applications can be added, applications not needed can be removed and existing applications can be modified industry- or customer-specifically by, for example, the customer himself, by sales or by the OEM (machine manufacturer or application service provider) without special development environment. A user of the control and/or regulating device is now only confronted with parameters and functions which are needed in his application. This reduces the time needed for commissioning. The possibilities for parameterization errors are greatly restricted and the diagnostics are simplified. Individual parts of a drive device up to a complete compound device, e.g. a six-axis machine tool can be preset including the topology. This selection can be made, e.g., by the manufacturer, e.g. for numeric control or a drive device. Particular advantages are obtained in conjunction with the above-mentioned loadable macros. These can run automatically during the first commissioning and change the parameters in their attributes in dependence on the plant configuration which has at least one control and/or regulating device. This happens automatically, for example in dependence on the components found. For example, process signal connections can also be established between components found. Following this, these settings can be concealed by an application-specific view and protected against adjustment or modification. This is an important step towards the one-button setting of an entire device or of parts of a device.

1-12. (canceled)

13. A method for adapting attributes of parameters of a control and/or regulating device, in particular of a control and/or regulating device for a machine tool or production machine, wherein a parameter has one or more attributes, the method comprising the step of defining and/or changing one or more attributes of a plurality of parameters by way of at least one set of data describing the one or more attributes.

14. The method of claim 13, further comprising the step of using the at least one set of data that describes the one or more attributes to adapt parameters of the control and/or regulating device to an application, wherein adaptation of the parameters of the control and/or regulating device relates to an adaptation of the attributes of the parameters and wherein the attributes of the parameters are changed and/or defined by the adaptation.

15. The method of claim 14, wherein in the adaptation of the parameters of the control and/or regulating device, a plurality of parameters are changed in at least one of the following points:
adaptation of a preset value,
adaptation of a permissible range of values,
adaptation of a visibility of a parameter on a display,
adaptation of an access right,
adaptation of a legibility setting,
adaptation of a writeability setting,
adaptation of a storage authorization,
of a parameter, wherein the at least one point is described by the attributes of the parameters.

16. The method of claim 13, wherein the at least one set of data describing the one or more attributes defines values of the parameters.

17. The method of claim 13, wherein the parameters of the control and/or regulating device have reset values which are defined by the at least one set of data describing the one or more attributes.

18. The method of claim 13, wherein the control and/or regulating device or a memory device accessible by the control and/or regulating device has at least two sets of data describing the one or more attributes, and further comprising the step of selecting one of the at least two sets of data, with the selected set of data being used for defining and/or changing the one or more attributes.

19. The method of claim 13, wherein changes of the one or more attributes are retained even after the control and/or regulating device is reset after the one or more attributes have been defined and/or changed.

20. A control and/or regulating device of a machine tool or a production machine, wherein parameters have attributes, wherein the attributes of a plurality of parameters can be defined and/or changed by means of at least one set of data describing the attributes.

21. The control and/or regulating device of claim 20, configured for executing a method for adapting attributes of parameters of the control and/or regulating device, wherein a parameter has one or more attributes, with one or more attributes of a plurality of parameters being defined and/or changed by way of at least one set of data describing the one or more attributes.

22. The control and/or regulating device of claim 20, wherein an attribute includes:
a preset value of a parameter, or
a minimum setup limit of a parameter, or
a maximum setup limit of a parameter, or
an information item on the visibility of a parameter, or
an information item on the legibility and/or writeability and/or storability of a parameter, or
an information item on an access right to a parameter,
wherein a parameter has one or more attributes.

23. The control and/or regulating device of claim 20, wherein the at least one set of data for the attribute description is an application-specific set of data.

24. The control and/or regulating device of claim 20, wherein the at least one set of data can be reloaded into the control and/or regulating device.
